(19) United States
(12) Patent Application Publication
(10) Pub. No.: US 2022/0377098 A1
(43) Pub. Date: Nov. 24, 2022

(54) AUTOMATIC DETECTION OF CLOUD-SECURITY FEATURES (ADCSF) PROVIDED BY SAAS APPLICATIONS

(71) Applicant: NetSkope, Inc., Santa Clara, CA (US)

(72) Inventors: Durgeshwar Pratap SINGH, Varanasi (IN); Naveen Y, Thanjavur (IN); Awadh Narayan SHUKLA, Bengaluru (IN)

(73) Assignee: NetSkope, Inc., Santa Clara, CA (US)

(21) Appl. No.: 17/384,644

(22) Filed: Jul. 23, 2021

(30) Foreign Application Priority Data
May 21, 2021 (IN) 202141022690

(51) Int. Cl. H04L 29/06; G06F 16/951; G06N 20/00; G06N 5/04

(52) U.S. Cl. CPC H04L 63/1433; G06F 16/951; G06N 20/00; G06N 5/04

(57) ABSTRACT

A method for scoring a cloud SaaS application to rate the level of cloud security provided by that application. The application URLs are crawled iteratively for data corresponding to a set of predetermined features using keyword strings. The features are determined to be those which are indicative of effective cloud security. The crawled data corresponding to features are stored in text files. The data are used for training and supervised machine learning algorithm to determine the probability score that a feature is present for that application. The feature scores are numerically combined to arrive at an overall cloud confidence index score (CCI) for that application. Every SaaS application is rated with a score between 1 and 100, depending on whether the selected features are present or not. The CCI score provides an easy way to determine the level of cloud security provided the application. It also provides a way to compare different SaaS applications as to their effectiveness in providing cloud security.

### CROSS-REFERENCE

This application claims priority to Indian Application No. 202141022690, titled AUTOMATIC DETECTION OF CLOUD-SECURITY FEATURES (ADCSF) PROVIDED BY SAAS APPLICATIONS, filed 21 May 2021 (Attorney Docket No. NSKO 1054-1).

### FIELD OF THE TECHNICAL DISCLOSED

The disclosed technology is an automated system and method for evaluating and scoring software as a service (SaaS) applications. With the disclosed technology, the cloud security features of a cloud application are automatically detected, scored, and numerically combined, providing the application with an overall score, indicative of the level of cloud security provided by that application.

### BACKGROUND

The subject matter discussed in the section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Software as a service (SaaS) refers to complete applications provided over a network that a vendor makes available for users, particularly to subscribing users. The SaaS applications typically work “right out of the box,” and typically do need additional development resources. Usually, the user is completely dependent on the vendor for all the features of the application. A cloud security company, such as Netskope, must evaluate thousands of these SaaS applications, as they become available. The applications are evaluated and classified to provide a cloud confidence index (CCI), which is a measure, on a scale of 0-100, of the level of network and cloud security provided by the vendor of an application. Applications with a high-level score, 70-100, are deemed safe applications for use on client networks. Applications with a low level score, 60 or lower, are considered risky applications, which should be avoided because they provide inadequate network security features.

Evaluation of these features for each SaaS application is customarily a lengthy manual process. More than 40 different criteria, corresponding to the features of the application, must be considered and scored. The score of all the features are numerically combined to arrive at the overall Cloud Confidence Index (CCI) score.

### BRIEF DESCRIPTION OF THE DRAWING

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 illustrates the prior manual research approach to evaluating a single SaaS application, generating a final CCI score between 0-100.

FIG. 2 illustrates a histogram plot of the most frequent keywords extracted from data related to the feature of Intellectual Property Legal Rights.

FIG. 3 illustrates the probability scores related relevant content with respect to the feature of Intellectual Property Legal rights.

FIG. 4A illustrates the workflow of the automated research process ADCFS.

FIG. 4B illustrates the workflow for training and using the supervised machine learning model in the automated research process ADCFS.

FIG. 5 illustrates in schematic form a computer system that can be used to implement the technology disclosed.

FIG. 6 illustrates graphical data showing that the automated the research process, ADCFS, greatly accelerates the research velocity for evaluating SaaS application.

FIG. 7 illustrates that ADCSF as a hybrid process greatly enhances the number of SaaS applications evaluated in a designated time period, while also reducing the number of errors per application.

### DETAILED DESCRIPTION

### Workflow of the Manual Research for an Individual Application

The dangers of cyber security are well-known and it is incumbent on cloud security companies, such as Netskope, to assess the dangers to users from using cloud-based applications such as software-as-a-service (SaaS) applications. It is useful to provide a numerical scoring system, so that a user may quickly judge whether a SaaS cloud application provides a danger to the user's network. For example, Netskope, Inc., provides a numerical score for cloud-based SaaS applications called the Cloud Confidence Index (CCI). A high score means that the application provides sufficient security, and a low score indicates inadequate security and is a signal to users that the application should be avoided.

In Netskope. Inc., the research and scoring of SaaS applications has been done manually since the start of the Netskope and other cloud security companies.

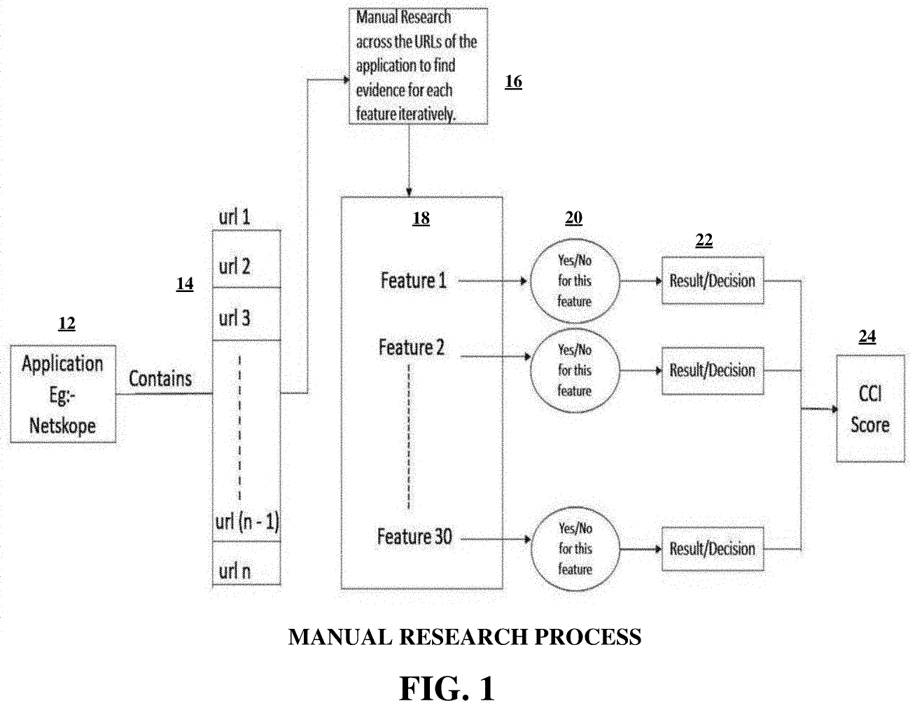

The manual evaluation process is shown in FIG. 1. The application 12 to be scored is shown has possibly hundreds of associated URLs 14 which must be scanned for relevant. Up to now, this is been a manual process 16. Each feature 18 of a list exceeding forty, must be individually evaluated through manual research. The result of all this research is a “yes” or “no” 20 for each feature 18. On this basis, a decision for each result/decision 22 for each feature is determined. All the results are numerically combined to arrive at a CCI score 24.

The more security-related features that are detected for particular application related to a feature, the higher the CCI score, which in turn indicates a higher level of cloud security.

The manual process has at least two drawbacks. The manual process is time-consuming, limiting the number of applications that can be researched in a set time. In the manual research process, a team of analysts looks for each of a listing of more than 40 features in the applications URLs. Usually this research involves iteratively performing a Google search to determine whether a certain features provided in an application or not. This is an exhaustive process, consuming manual effort as well as time needed to investigate whether the information related to a particular feature is provided by an application or not. The manual process also introduces manual errors due to human error. The disclosed technology seeks to eliminate the drawbacks in manual evaluation of applications.

### Cloud Confidence Index Factors

As described, the manual evaluation of those applications is complex and time-consuming. For each SaaS application, the researcher takes up a question/feature list and looks for evidence to prove that the application provides this particular feature or not, across all the URLs of the application. If proof is found, the answer will be YES. If no proof is found, the answer is NO. The process is performed iteratively for each feature of the application. Ultimately, more than 40 features will be classified as YES or NO. Based on these results, the CCI score for the application will be calculated. This methodology must be applied to all SaaS applications in the Netskope database.

The disclosed technology automates the process of evaluating the security level of SaaS using machine learning algorithms to automate the process.

From an evaluation of hundreds of SaaS applications provided by the cloud, certain factors have been determined to indicate the level of cloud security provided by those applications. The following is an example listing of those features considered important in the evaluation of cloud-based SaaS applications. In accordance with the technology disclosed, other features may be added to this list, and some features may be deleted or augmented in some way as required.

### Features To Be Evaluated for Cloud-Based SaaS Applications

### Certifications and Standards

What compliance certifications does the app have?

To what data center standards does the app adhere?

### Data Protection

Does the app allow data classification (e.g., public, confidential, proprietary)?

If yes, does the app allow admins to take action on classified data (e.g., encrypt, control access)?

Does the app encrypt data-at-rest?

Does the app encrypt data-in-transit?

Does the app increase the risk of data exposure by supporting weak cipher suites?

Does the app increase the risk of data exposure by supporting weak signature algorithm or key size?

Does the app allow customer-managed encryption keys?

Data segregated by tenant?

Which HTTP security headers does the app use?

Does the app vendor use a Sender Policy Framework to protect customers from spam and phishing emails?

Does the app enable file sharing?

File Sharing Capacity?

Does the app allow anonymous sharing of data?

Does the app allow signup without a credit card?

The list of platforms through which the app traffic can be proxied?

### Access Control

Does the app support role-based authorization?

Does the app enforce authorization policies on user activities?

Does the app support access control by IP address or range?

Does the app enforce password best practices as policy?

SSO/AD hooks?

Does the app support multi-factor authentication?

Does the app support the following device types?

Is all customer data erased upon cancellation of service? If so, when?

From which countries does this app serve data?

### Auditability

Does the app provide admin audit logs?

Does the app provide user audit logs?

Does the app provide data access audit logs?

### Disaster Recovery and Business Continuity

Does the app vendor provide infrastructure status reports?

Does the app vendor provide notifications to customers about upgrades and changes (e.g., scheduled maintenance, new releases, software/hardware changes)?

Does the app vendor back up customer data in a separate location from the main data center?

Does the application vendor utilize geographically dispersed data centers to serve customers?

Does the app vendor provide disaster recovery services?

Which infrastructure or hosting provider is the app hosted on?

### Legal and Privacy—Legal

Who owns the data/content uploaded to the application site? Does the customer own the data or does the application vendor own the data?

Is the customer data available for download upon cancellation of service?

Is all customer data erased upon cancellation of service? If so, when?

From which countries does this app serve data?

### Legal and Privacy—Privacy: Mobile

Does this application access contacts, calendar data and messages?

Does this application access other apps on the device?

Does this application perform system operations?

Legal and Privacy—Privacy: Browser

Does this app share users' personal information (e.g., name, email, address) with third parties?

Does this application use third-party cookies?

### Vulnerabilities & Exploits

Has this application been recently breached (in the past year)?

### The Evaluation Model

According to the listing given above, a researcher starts with a SaaS application with more than 40 features, questions, attributes. An example of the security features may include, for example:
Does the app support role-based authorization?
Does the app encrypt data-at-rest?

For each SaaS application, the researcher takes up a question/feature list and looks for evidence to prove that the application provides this particular feature or not, across all the URLs of the application. If proof is found, the answer will be YES. If no proof is found, the answer is NO. The process is performed iteratively for each feature of the application. Ultimately, more than 40 features will be classified as YES or NO. Based on these results, the CCI score for the application will be calculated. This methodology must be applied to all SaaS applications in the application database. The disclosed technology scores every SaaS application between 0-100, depending on whether the set of features are provided or not to provide an overall CCI score following the workflow described in connection with shown in FIG. 1.

### Workflow of the Automated ADCSF System

The present technology automates the research process, using artificial intelligence to determine CCI's by the addition of an automated engine that fetches relevant and accurate proofs for a set of specified features of SaaS applications. The disclosed technology evaluates more than 40 related security features (attributes) for each SaaS application contribute to a CCI (Cloud Confidence Index) score, which is a measure of the security level of a cloud application. The automated ADCSF system fetches the appropriate evidence for a feature of an application within seconds, in contrast to the slow manual research process it replaces.

The ADCSF system significantly reduces the time it takes the researcher to complete the evaluation of an application. Also, many researcher errors which happen in the manual search are eliminated by the automated process. The ADCSF overcomes manual errors by rendering the appropriate evidence which directly impacts the CCI Score.

### Crawling the SaaS Application URLs

The disclosed ADCSF technology automatically fetches the appropriate evidence for a listed feature of an application in a short time span using web crawling.

Crawling is the process of automatically searching through websites and obtaining data from those websites via a software program. The crawler uses a search algorithm to analyze the content of a URL page looking specified content to fetch and index. In the context of the present technology, crawling describes searching for the more than forty features from possibly 4000 to 8000 web sites associated with the particular application being scanned by using keywords.

### Keyword Combinations

To evaluate a new SaaS application, all the application URLs are crawled, and the relevant content of each URL is placed in a corresponding text file for that feature. The ADCSF system crawls the application web site URLs iteratively for each feature using preselected keyword combinations to locate single or multiple sentences supporting each feature, and creates more than 40 bins of test data, each bin corresponding to one feature.

The keyword combinations for each feature have been selected based on manual examples from prior analysis, historical data, and statistical data, which have been shown to result in valid prediction of the features. Examples for 40 features are extracted from about 4,000 to 18,000 sites used. For each factor, a score is included, and extracted sentences from a web page on the site are provided as evidence. The examples provide the ground truth data provided by direct observation, which is the evidence used in training the machine learning model used in the disclosed technology, as will be described.

Also, the researcher can specify the limit on the number of pages/URLs to be crawled. For example, the command may be “crawl the top 500 pages of an application.” The crawler is also capable of blocking particular URLs if provided as an exclusion list.

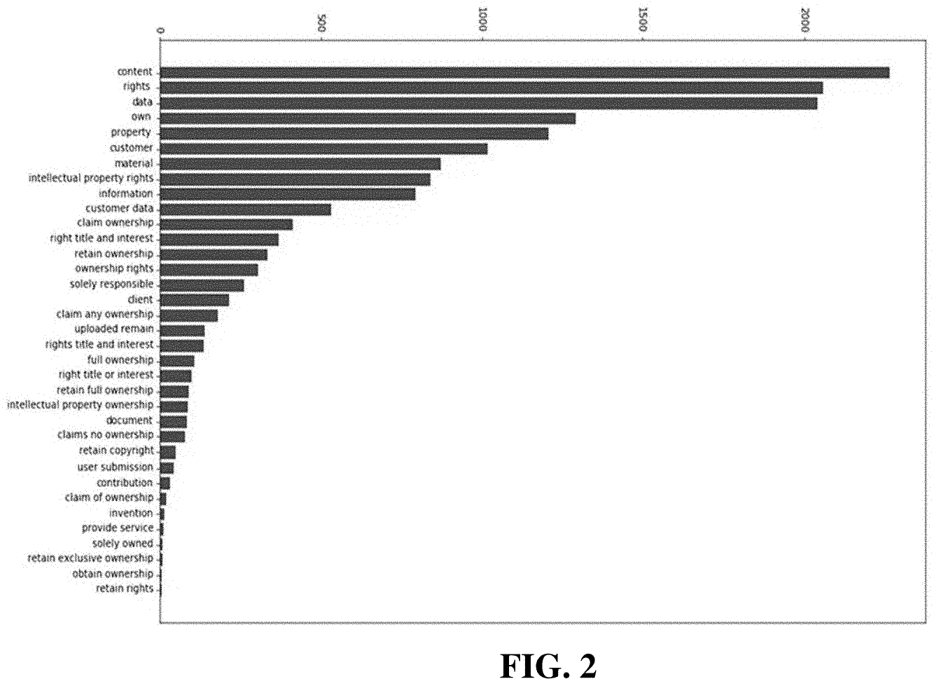

This is illustrated in FIG. 2. A frequency of keywords are used to select sentences to analyze. This example in FIG. 2 concern ownership and intellectual property rights. The system fetches the most frequent keywords from this data, and creates a plot. From the manual examples, a histogram of keywords is constructed for each factor and used to augment expert supplied keywords for the factors. These words are used to select sentences to analyze in production phase, where supervised machine learning algorithm is applied to the data.

After fetching the most frequent keywords from the data, these keywords are used to represent the sample in the training data for the ML algorithm. For example, if the evidence is “Ownership of Your Content as between you and us, you retain all right, title and interest in and to Your Content and all Intellectual Property Rights in Your Content.”, the combination of keywords that represent this proof text would be [‘ownership’, ‘retain’, ‘your content’, ‘intellectual property rights’]. The system maps each sample in the data to a list of keyword combinations which summarize the sample. An example of list of such combinations might be:
{[‘customer’, ‘own’, ‘rights’, ‘content’], [‘retain’, ‘ownership’, ‘data’], [‘your data’, ‘belong’, ‘you’]}

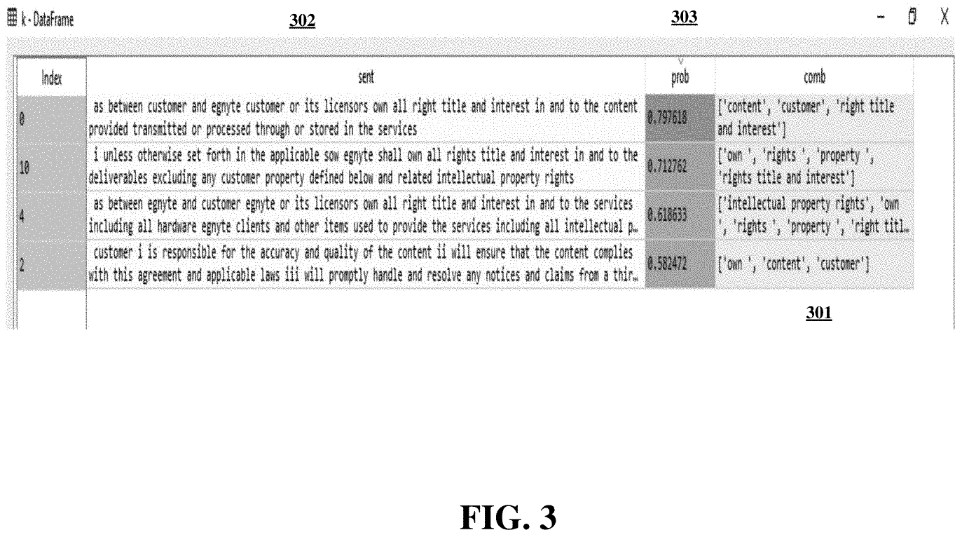

In FIG. 3, the list of keyword combinations 301 is iterated over the crawled content of each of the URLs, one of the time, and the system collects the sentence or sentences matching any of the combinations. For instance, if the URL is “https://www.egnyte.com/terms-of-service,” the sentence matching the combination ([‘content’, ‘customer’, ‘own’, ‘right, title and interest’]) would be “As between Customer and Egnyte, Customer or its licensors own all right, title and interest and to the Content provided transmitted or processed through, or stored in, the Services.”

For each relevant sentence obtained 302, the model will generate a corresponding probability score 301, based on the keywords or combinations of keywords, as shown in FIG. 3.

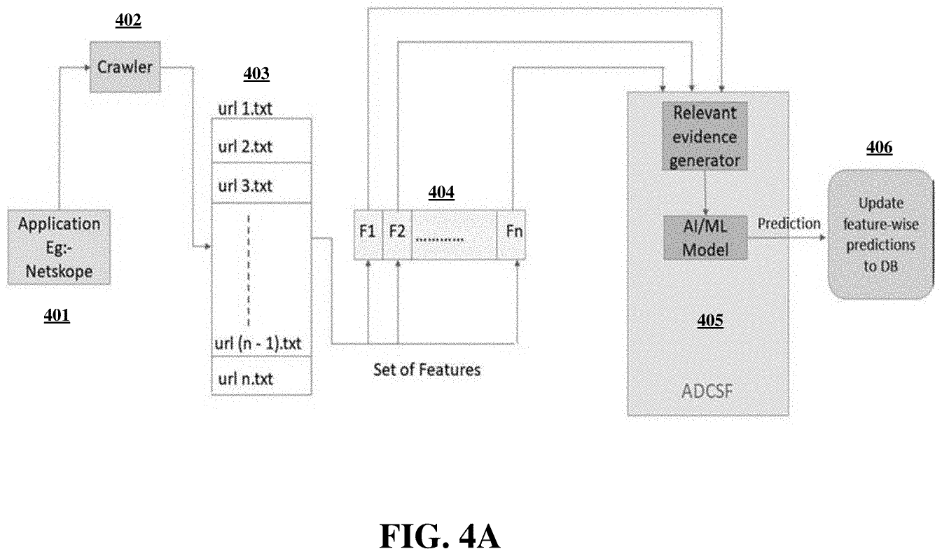

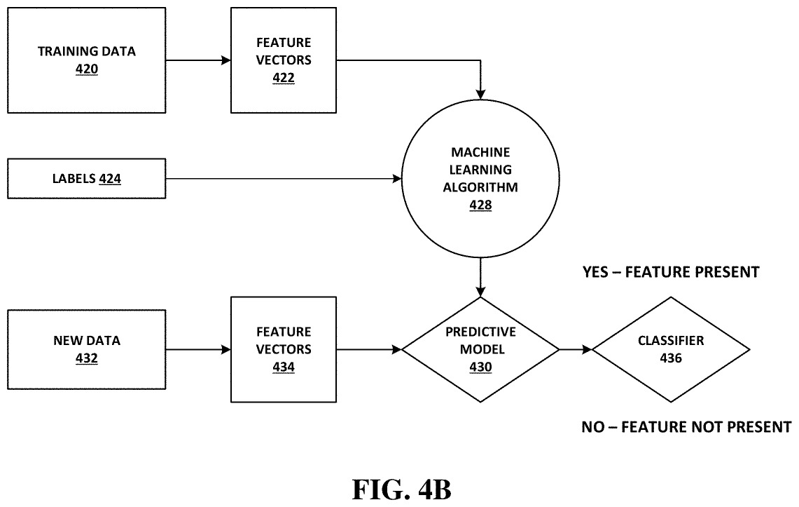

The workflow of the automated research process (ADCSF) is shown in FIG. 4A. The application under review 401 is crawled 402. All the URLs 403 associated with that application are crawled iteratively. The set of features numbering more than forty are search will keywords and keyword combinations are search iteratively 404 and stored in a bin 405. The relevant sentences associated with each keyword and keyword combinations are stored as ground truth data or evidence. The relevant evidence are used in machine learning model 405 for training and then for production. The machine learning model 405 predicts and classifies the data for each feature, and this result is used in calculating the CCI score.

FIG. 4B illustrates the training of a supervised machine learning model 430. The training uses a suitable supervised machine learning algorithm 428. It is preferable to use a machine learning algorithm such as Linear SVC (Support Vector Classifier), or an alternative ML classifier algorithm that provides an equivalent capability. In supervised machine learning, training data includes classification labels 424. Training data 420 are used to extract features. Ideally this sampling should be large, on the order of a thousands of samples, to be extracted.

When the feature vectors 422 are identified and labeled, they are combined by the machine learning algorithm 428 to create the predictive model 430. New unlabeled data 432 are classified through the selected feature vector 434 and input into the predictive model 312. The predictive model processes 430 the new data 432 and provides the YES or NO expected label 436 as an end result of a classifier.

### ML Engine Classifier

The automated process uses supervised machine learning in the classification tasks to create a set of labeled training data pertaining to each label/class, so that a classification algorithm can learn to draw a decision boundary to separate the classes. In the disclosed technology, training data may be available in one class while not having the same data for another class. The challenge of the automated system is to find, out of thousands of possible webpage URLs in an new application, those webpages which have the relevant proof for a particular feature, which will become input of the trained ML Model.

When the training data set is ready, a Classifier is constructed on this concatenated data which will be used to determine the decision scores of the fetched relevant proof from URL webpages. Relevant proofs from crawled content in the text file are in the form of fetched sentences. The fetched sentences are those relevant sentences to be input into the machine learning model for prediction. It is preferable to use a machine learning algorithm such as Linear SVC (Support Vector Classifier), or an alternative ML classifier algorithm that provides an equivalent capability.

### Augmenting the Data

The system uses the manually-researched applications with feature-specific proofs which will be the data for YES class. The proof for the NO class will not be available. In order to build a ML model, data will be required for both classes. To address this NO class issue problem, data is augmented with synthetic non-contextual data for sites where no evidence was found for a feature. Nonsense sentences augment the missing score, making sure that the nonsense sentences do not include any keywords. This data is used to train the LinearSVC or other classifier.

For each relevant sentence obtained, the model gives a corresponding probability score as illustrated in FIG. 3. The probability score indicates a level of confidence that the particular evidence is relevant to the feature. The higher the probability score, the higher the probability that the relevant sentence is proof for the feature. A probability threshold (attribute-specific) is set based on experimentation, so that misclassification on both the classes is minimal. If the probability of a certain proof is greater than this particular threshold, the proof is added to a .csv file.

For example, if an application has 1000 URLs and 3 URLs out of 1000 have relevant content with respect to a particular feature, these 3 relevant proofs are added into the data frame with their probability scores, sorted in descending order. This is illustrated in FIG. 3.

### Computer System

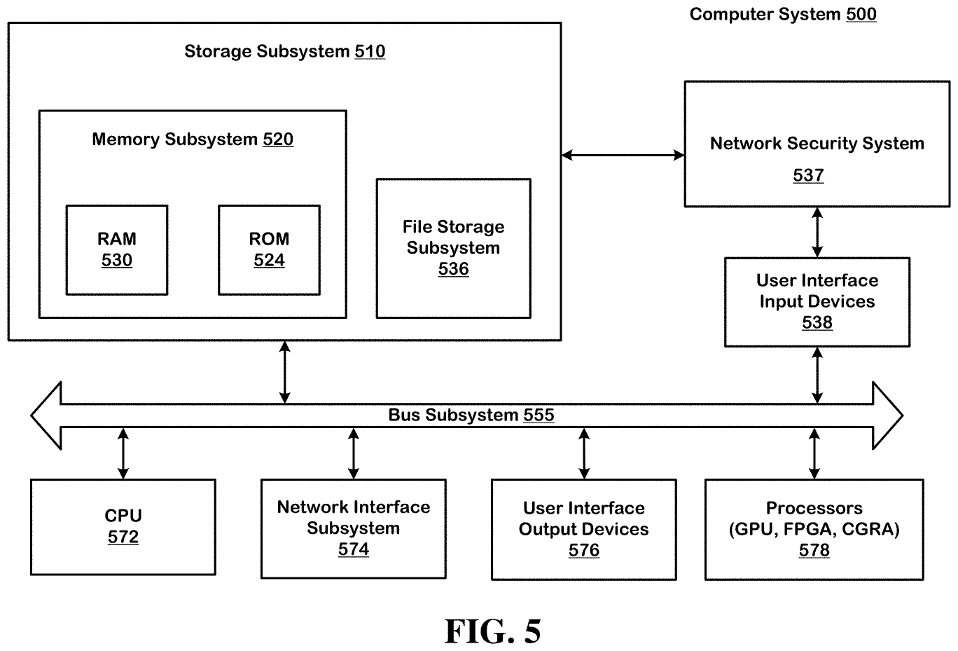

FIG. 5 is a computer system 500 that can be used to implement the technology disclosed. Computer system 500 includes at least one central processing unit (CPU) 572 that communicates with a number of peripheral devices via bus subsystem 555. These peripheral devices can include a storage subsystem 510 including, for example, memory devices and a file storage subsystem 536, user interface input devices 538, user interface output devices 576, and a network interface subsystem 574. The input and output devices allow user interaction with computer system 500. Network interface subsystem 574 provides an interface to outside networks, including an interface to corresponding interface devices in other computer systems.

In one implementation, the Network Security System 537 is communicably linked to the storage subsystem 510 and the user interface input devices 538.

User interface input devices 538 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 500.

User interface output devices 576 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 500 to the user or to another machine or computer system.

Storage subsystem 510 stores programming and data constructs that provide the functionality of some or all of the modules and methods described herein. These software modules are generally executed by processors 578.

Processors 578 can be graphics processing units (GPUs), field-programmable gate arrays (FPGAs), application-specific integrated circuits (ASICs), and/or coarse-grained reconfigurable architectures (CGRAs). Processors 578 can be hosted by a deep learning cloud platform such as Google Cloud Platform™, Xilinx™, and Cirrascale™. Examples of processors 578 include Google's Tensor Processing Unit (TPU)™, rackmount solutions like GX4 Rackmount Series™, GX18 Rackmount Series™, NVIDIA DGX-1™, Microsoft' Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa VlOOs™, and others.

Memory subsystem 520 used in the storage subsystem 510 can include a number of memories including a main random access memory (RAM) 530 for storage of instructions and data during program execution and a read only memory (ROM) 524 in which fixed instructions are stored. A file storage subsystem 536 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 536 in the storage subsystem 510, or in other machines accessible by the processor.

Bus subsystem 555 provides a mechanism for letting the various components and subsystems of computer system 500 communicate with each other as intended. Although bus subsystem 555 is shown schematically as a single bus, alternative implementations of the bus subsystem can use multiple busses.

Computer system 500 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 500 depicted in FIG. 18 is intended only as a specific example for purposes of illustrating the preferred implementations of the present invention. Many other configurations of computer system 500 are possible having more or less components than the computer system depicted in FIG. 5.

Each of the processors or modules discussed herein may include an algorithm (e.g., instructions stored on a tangible and/or non-transitory computer readable storage medium) or sub-algorithms to perform particular processes. A module is illustrated conceptually as a collection of modules, but may be implemented utilizing any combination of dedicated hardware boards, DSPs, processors, etc. Alternatively, the module may be implemented utilizing an off-the-shelf PC with a single processor or multiple processors, with the functional operations distributed between the processors.

As a further option, the modules described below may be implemented utilizing a hybrid configuration in which certain modular functions are performed utilizing dedicated hardware, while the remaining modular functions are performed utilizing an off-the-shelf PC and the like. The modules also may be implemented as software modules within a processing unit.

Various processes and steps of the methods set forth herein can be carried out using a computer. The computer can include a processor that is part of a detection device, networked with a detection device used to obtain the data that is processed by the computer or separate from the detection device. In some implementations, information (e.g., image data) may be transmitted between components of a system disclosed herein directly or via a computer network. A local area network (LAN) or wide area network (WAN) may be a corporate computing network, including access to the Internet, to which computers and computing devices comprising the system are connected. In one implementation, the LAN conforms to the transmission control protocol/internet protocol (TCP/IP) industry standard. In some instances, the information (e.g., image data) is input to a system disclosed herein via an input device (e.g., disk drive, compact disk player, USB port etc.). In some instances, the information is received by loading the information, e.g., from a storage device such as a disk or flash drive.

A processor that is used to run an algorithm or other process set forth herein may comprise a microprocessor. The microprocessor may be any conventional general purpose single- or multi-chip microprocessor such as a Pentium™processor made by Intel Corporation. A particularly useful computer can utilize an Intel Ivybridge dual-12 core processor, LSI raid controller, having 128 GB of RAM, and 2 TB solid state disk drive. In addition, the processor may comprise any conventional special purpose processor such as a digital signal processor or a graphics processor. The processor typically has conventional address lines, conventional data lines, and one or more conventional control lines.

The implementations disclosed herein may be implemented as a method, apparatus, system or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices. In particular implementations, information or algorithms set forth herein are present in non-transient storage media.

### Advantages over Manual Research Methods

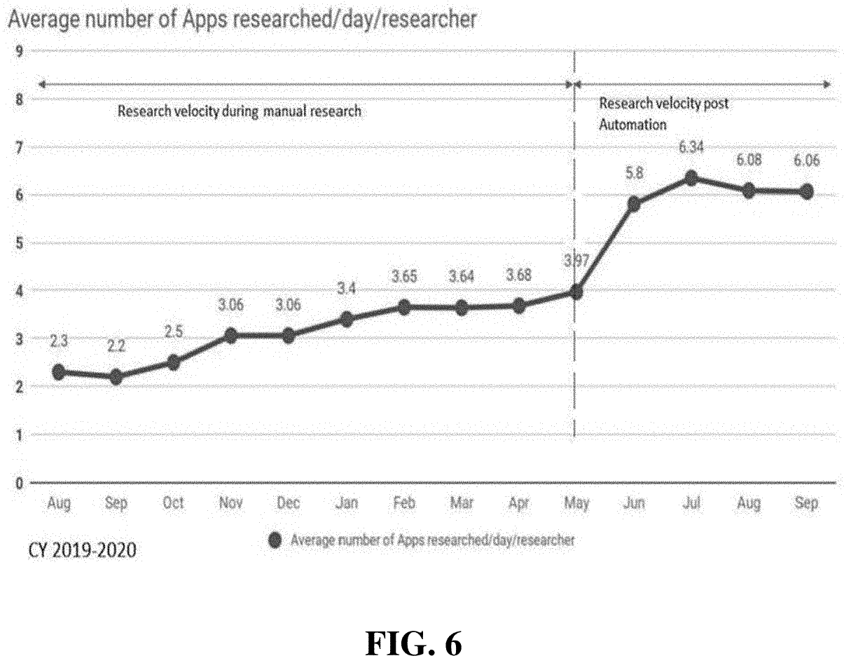

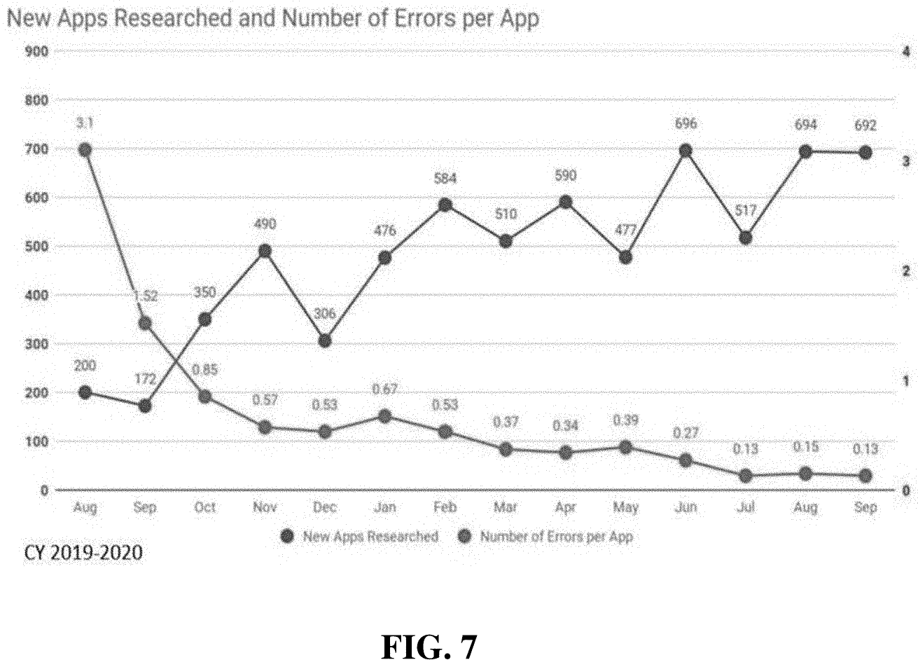

The disclosed technology has several advantages over prior approaches. It makes the process of classification significantly faster and more efficient by reducing manual evaluation. FIG. 6 shows a comparison between manually researched applications versus automated research. The velocity (speed of evaluating new SaaS applications) when 40% of the features are automated is 2× the manual rate. For 80% automated evaluation, the research velocity would be 4×. For 100% automated evaluation, the research velocity would be 5×, where x stands for manual research velocity. FIG. 7 also shows that improved accuracy is achieved with the automated process, greatly reducing manual research errors.

The project goal is to have 100,000 SaaS applications researched in the Netskope database by CY-2023. With only manual research in place, this goal is nearly impossible to achieve. By deploying the automated ADCSF technology along with the hybrid research process, this goal will be achievable. It is contemplated that one implementation of the disclosed technology would be a hybrid combination of manual research and ADCSF.

### PARTICULAR IMPLEMENTATIONS

The technology disclosed can be practiced as a system, method, device, product, computer readable media, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections. These recitations are hereby incorporated forward by reference into each of the following implementations.

The technology disclosed relates to a system and method for scoring a cloud SaaS application to rate the level of cloud security provided by that application. The application URLs are crawled iteratively for data corresponding to a set of predetermined features using keyword strings. The features are determined to be those which are indicative of effective cloud security. The crawled data corresponding to features are stored in text files. The data are used for training and using a supervised machine learning algorithm to determine the probability score that a feature is present for that application. The feature scores are numerically combined to arrive at an overall cloud confidence index score (CCI) for that application. Every SaaS application is rated with a score between 1 and 100, depending on whether the selected features are present or not. The CCI score provides an easy way to determine the level of cloud security provided the application. It also provides a way to compare different SaaS applications as to their effectiveness in providing cloud security.

It has been determined by the inventors of the disclosed technology that the evaluation of a new cloud-based SaaS application depends on certain factors, both positive and negative. If enough positive factors are present, it is likely that the new application will provide sufficient cybersecurity protection to a user of that new application.

In one aspect of the present invention, a method is provided for scoring a cloud-based SaaS application to rate the level of cloud security provided by the application. A the relevant application URLs are crawled iteratively for data corresponding to a set of selected features, and storing the data in text files corresponding to each of the plurality of features. There are more than forty features that are believed to be relevant, from historical data. The data in the stored text files are then searched to identify keywords and key keyword combinations. Using the keyword combinations, the text files are searched. The resulting data provide samples for training a supervised learning algorithm. The labeled training data is used to train a machine learning model to recognize each feature. The training data also includes historical data and synthetic non-contextual data to balance the samples. The data from the keyword search includes feature relevant sentences that match the keyword combinations. This is the proof data. It is these sentences that are provided to the predictive model, generated by the machine learning algorithm. The predictive model drives a classifier to determine if a feature is present or not present, depending on whether the probability score exceeds a predetermined threshold, which would indicate that a features present. A low probability score would indicate that a feature is not present. When all the features have been analyzed in this fashion, the individual proof scores are combined numerically to arrive at an overall Cloud Confidence Index (CCI) score.

In another aspect of the disclosed technology, the Cloud Confidence Index score is between 1 and 100, which provides a convenient basis for comparing CCI's for multiple one applications. In this case, a user attempting to decide between one application and another can compare scores from the different applications and make a choice for what application to use based on its cloud security features. Since all the application CCI's are stored in a database, user having access to the database will be provided with a great deal of information upon which to make a decision. As new applications become available, they will be scored and added to the updated database. The database will eventually include thousands of applications that have been evaluated by this automated scoring method. The user will have ample data to determine which application websites are safe and which are not.

In another aspect, the relevant sentences recovered from the data provide ground truth data for a particular feature, i.e. direct evidence.

There are more than 40 features which have been determined to be important in the determination of cloud security for particular applications, and each feature must be separately scored, and then combined into the overall CCI score. Each feature will have its own set of keywords and keyword combinations, which is used to extract relevant data in the form of sentences, which are imported into the machine learning predictive model and classifier to obtain a classification score.

In another aspect, the disclosed technology is a computer-based system for scoring cloud-based SaaS applications to rate the level of cloud security provided by that application. One feature of the disclosed system is a web crawling application for crawling a plurality the application URLs iteratively for data corresponding to a set of features, and storing the data in text files corresponding to each of the plurality of features. A machine learning algorithm trained to recognize when the set of features are present in any of the text files. The system includes a predictive model for recognizing when a predetermined feature is present in an application URL or many application URLs. A classifier is provided to determine if a predetermined feature is present or not present. The machine learning classifier is a linear SVC classifier, ideally, but other classifiers may be used. A combiner numerically combines the individual proof feature scores to arrive at an overall Cloud Confidence Index (CCI) score.

In another aspect, the training data for the machine learning model includes historical data and synthetic non-contextual data. The system compiles CCI scores for a plurality of web sites for potentially thousands of applications. All the scores in relevant data that contribute to the scores are stored in a database which can be made available to users when they are evaluating or choosing new cloud-based applications.

In another aspect of the present technology, the CCI score may be modified by customized weightings of the individual features, and in another aspect, the analysis may be performed using a hybrid method combining manual and automated machine learning methods

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

1. A method for scoring a cloud-based SaaS application to rate a level of cloud security provided by that application, the method including actions of:
crawling a plurality of uniform resource locators (URLs), associated with a cloud based software as a service (SaaS) application, said crawling being for extracting data corresponding to a set of security features, said security features being attributes of said application that provide cybersecurity protection, to a user of said application, and storing said data into text files corresponding to each feature of said set of security features;
searching said text files to identify frequently used keyword combinations;
identifying for each said feature of said set of security features, relevant sentences that match any of said keyword combinations to derive proof data;
for each said feature of said set of security features, inputting said relevant sentences into a machine learning model to derive a corresponding probability score for each said feature;
for each said feature of said set of security features, adding a proof feature score to a data file when said probability score for each said feature exceeds a predetermined threshold; and
numerically combining each said proof feature score to arrive at an overall Cloud Confidence Index (CCI) score for said application; and wherein
the above actions being implemented via computer readable instructions being stored within a non-transitory computer readable storage medium, said computer readable instructions being executed via at least one central processing unit (CPU).

2. The method scoring of claim 1, wherein the overall Cloud Confidence Index is between 1 and 100.

3. The method for scoring of claim 1, wherein a plurality of scores for different applications are stored in a CCI database.

4. The method for scoring of claim 3, wherein CCI score is accessible to users to determine which websites are safe and which are not.

5. The method of claim 1, including an action of recovering relevant sentences using the word combinations, wherein the relevant sentences provide ground truth data for the particular feature.

6. The method of claim 1, wherein the number of URL's crawled is preset to a limit.

7. The method of claim 1, wherein relevant sentences are recovered by keyword combinations, and stored separately for each feature.

8. The method of claim 1, wherein the relevant sentences collected for each feature are imported into machine learning predictive model and classifier to obtain a classification score.

9. The method of claim 1, including an action of extracting sentences from a web page to provide evidence of a feature scanned using keyword combinations indicative of a particular feature.

10. A computer-based system for scoring a cloud-based SaaS application to rate the level of cloud security provided by that application, the system comprising:
a web crawling application for crawling a plurality of uniform resource locators (URLs) associated with a cloud based software as a service (SaaS) application, said crawling being for extracting data corresponding to a set of predetermined security features, said security features being attributes of said (SaaS) application that provide cybersecurity protection to a user of said (SaaS) application, and storing said data into text files corresponding to each feature of said set of security features;
a machine learning algorithm trained to recognize when each feature of said set of security features is present in any of said text files;
a predictive model for recognizing when a feature of said set of security features is present in a SaaS application URL,
a classifier to determine if said feature of said set of security features is present or not present in a (SaaS) application URL;
a combiner for numerically combining individual proof feature scores to arrive at an overall Cloud Confidence Index (CCI) score for said (SaaS) application, and wherein
the system being implemented as computer readable instructions being stored within a non-transitory computer readable storage medium, said computer readable instructions being executed via at least one central processing unit (CPU).

11. The system of claim 10, wherein said web crawling application includes a searching algorithm based on keyword combinations to locate data relevant to said set of security features in said (SaaS) application URLs.

12. The system of claim 10, wherein the machine learning algorithm is trained via training data that includes historical data and synthetic non-contextual data.

13. The system of claim 10, further including a compiler for compiling a CCI score for each of a plurality of websites.

14. The system of claim 10 wherein the classifier is a linear SVC classifier.

15. The method of claim 1, further including extracting a histogram of keywords for each factor to augment expert supplied keywords for the factors.

16. The method of claim 15, wherein the keywords used to select sentences are derived at least from histogram statistical analysis.

17. The method of claim 1, further including an action of combining classification scores into an overall CCI score using custom feature weightings.

18. The method of claim 1 wherein the selected features extracted from the crawled application URL's of the SAAS application include at least three of the following:
certifications and standards;
data protection;
access control;
auditability;
disaster recovery and business continuity;
legal and privacy for mobile;
legal and privacy for browser; and
known vulnerabilities.

19. The method of claim 1 wherein the selected features extracted from the crawled application URL's include at least five of the following:
compliance certifications;
data center standards;
data classification;
allow admins to take actions of encryption and/or access control on classified data;
encrypt data-at-rest;
encrypt data-in-transit;
data exposure by supporting weak cipher suites;
increase data exposure by supporting weak signature algorithm or key size;
customer-managed encryption keys;
data segregated by tenant;
HTTP security headers;
sender policy framework to protect customers from spam and phishing emails;
enable file sharing;
file sharing capacity:
anonymous sharing of data:
signup without a credit card:
app traffic proxied through platforms:
role-based authorization;
enforce authorization policies on user activities;
access control by IP address or range;
password best practices as policy;
SSO/AD hooks;
multi-factor authentication;
data types supported;
customer data erased upon cancellation of service;
countries served by app;
admin audit logs;
user audit logs;
data access audit logs;
infrastructure status reports;
notifications to customers about upgrades and changes;
back up customer data in a separate location from the main data center;
utilize geographically dispersed data centers to serve customers;
disaster recovery services;
approved hosting provider;
ownership of data/content uploaded to the application site;
customer data available for download upon cancellation of service?
customer data erased upon cancellation of service;
source countries from which app serves data;
allow access to contacts, calendar data, and messages;
allow application access other apps on the device;?
enable system operation;
share users' personal information (name, email, address) with third parties;
third-party cookies; and
recent breaches.

20. The system of claim 10, wherein the machine learning algorithm is trained via automated methods and manual methods.
